(19) United States
(12) Patent Application Publication
(10) Pub. No.: US 2026/0085800 A1
(43) Pub. Date: Mar. 26, 2026

(54) TORCHIERE LAMP WITH DYNAMIC AMBIENT LIGHTING EFFECT

(71) Applicant: Dongguan Bopu Lighting Co., Ltd, Dongguan (CN)

(72) Inventors: Gaohui Liu, Dongguan (CN); Zhi Qiu, Dongguan (CN)

(21) Appl. No.: 19/333,351

(22) Filed: Sep. 19, 2025

(30) Foreign Application Priority Data
Sep. 20, 2024 (CN) 202422302065.3

(51) Int. Cl. F21S 10/02; F21V 1/10; F21V 3/02; F21V 5/04; F21V 14/02; F21V 17/06; F21Y 113/10

(52) U.S. Cl. CPC F21S 10/026; F21V 1/10; F21V 3/02; F21V 5/04; F21V 14/02; F21V 17/06; F21Y 2113/10

(57) ABSTRACT

The present invention is applied to the field of torchiere lamps, and specifically relates to a torchiere lamp with a dynamic ambient lighting effect. The torchiere lamp comprises a lighting assembly, the lighting assembly comprises a mounting plate, a lampshade, and a light-transmitting cover, an ambient light unit is mounted at a top portion of the mounting plate, a fixing frame is provided with a motor mounted thereon, an output end of the motor passes through a through hole and is fixedly connected to a light refraction sheet, a bottom portion of the lampshade is provided with a mounting groove in a convex mode, and a laser lamp is mounted in the mounting groove. Thus, changes in refracted light can be achieved, and the changing light is diverged via the light-transmitting cover, thereby increasing fun of using the torchiere lamp.

### CROSS-REFERENCE TO RELATED APPLICATIONS

This application claims priority to Chinese Patent Application No. 202422302065.3, filed on Sep. 20, 2024, which is hereby incorporated by reference in its entirety.

### TECHNICAL FIELD

The present invention relates to the technical field of torchiere lamps, and specifically relates to a torchiere lamp with a dynamic ambient lighting effect.

### BACKGROUND

Lamps and lanterns refer to appliances capable of transmitting light, distributing light, and changing light distribution of light sources, including, in addition to the light sources, all components and parts required to fix and protect the light sources, as well as wiring accessories necessary for connection to power sources. Modern lamps and lanterns include home lighting, commercial lighting, industrial lighting, road lighting, landscape lighting, and special lighting, etc.

A torchiere lamp is one of the lamps and lanterns, and is usually composed of a support mechanism, a connecting structure, and a lighting assembly. Existing torchiere lamps have a single function, and their lighting assemblies can only be used for luminous illumination, thus having a too monotonous applicable scenario, being unable to bring other better experience scenarios to users, and having a relatively limited user group.

### SUMMARY

An objective of the present invention is to provide a torchiere lamp with a dynamic ambient lighting effect, so as to solve the above problems put forward in the background art.

To achieve the above objective, the present invention provides the following technical solutions: a torchiere lamp with a dynamic ambient lighting effect comprises a lighting assembly, the lighting assembly comprises a mounting plate, a lampshade, and a light-transmitting cover, the lampshade is clamped to a top portion of the mounting plate, the light-transmitting cover is clamped to a top portion of the lampshade, an ambient light unit is mounted at the top portion of the mounting plate, the ambient light unit comprises a fixing frame, the fixing frame is provided with a motor mounted thereon, a lamp panel is mounted above the motor, the lamp panel is provided with a through hole, an output end of the motor passes through the through hole and is fixedly connected to a light refraction sheet, a bottom portion of the lampshade is provided with a second mounting groove in a convex mode, a laser lamp is mounted in the second mounting groove, and the top portion of the lampshade is provided with a laser lamp hole for divergence and transmission of light emitted from a light source of the laser lamp.

Preferably, a side wall of the mounting plate is provided with first clamping buckles in a convex mode, the bottom portion of the lampshade is provided with first clamping grooves, the mounting plate and the lampshade are clamped together via the first clamping buckles and the first clamping grooves, a top end of the lampshade is provided with a through groove, a side wall of the through groove is provided with a second clamping groove, both sides of the second clamping groove are provided with clamping blocks, a bottom end of the light-transmitting cover is provided with a second clamping buckle in a convex mode, the clamping blocks and the second clamping buckle are engaged and clamped together, and a bottom end of one side of each of the clamping blocks is provided with an inclined face for facilitating sliding of the second clamping buckle.

Preferably, top ends of both sides of the fixing frame are provided with third support grooves, both sides of the motor are provided with connecting lugs in a convex mode, both the connecting lugs and the lamp panel are provided with corresponding fixing holes, the fixing frame is provided with second connecting holes in communication with the fixing holes on bottom surfaces of the third support grooves, a bottom surface of the mounting plate is provided with first connecting holes in communication with the second connecting holes, the first connecting holes are threaded holes, and the motor and the lamp panel sequentially pass through the fixing holes and the second connecting holes and are connected to the first connecting holes in a threaded mode through bolts.

Preferably, a bottom portion of the mounting plate is provided with a first mounting groove for mounting a lighting lamp panel, and the first mounting groove abuts against a light-transmitting plate.

Preferably, the first mounting groove and the light-transmitting plate are both in a circular shape, two side walls of the first mounting groove are respectively provided with a first support groove and a second support groove, two side walls of the light-transmitting plate are both provided with abutting members in a convex mode, and the abutting members on two sides of the light-transmitting plate respectively abut against a side wall of the first support groove and a side wall of the second support groove.

Preferably, a center of the mounting plate is provided with a connecting threaded-groove, and the connecting threaded-groove is connected to a connecting structure.

Preferably, the connecting structure comprises a first connecting member, a support structure is clamped to a bottom end of the first connecting member, a top end of the first connecting member is fixedly connected to an intermediate member, a second connecting member is hinged to a top end of the intermediate member, the intermediate member is provided with a flipping groove, the intermediate member is provided with a ball groove at a bottom end of the flipping groove, a bottom end of the second connecting member is provided with a ball head in a convex mode, the ball head and the ball groove are connected in a spherical hinge mode, a top end of the second connecting member is provided with a threaded end in a convex mode, and the threaded end and the connecting threaded-groove are connected in a threaded mode.

Preferably, the support structure comprises a support rod, a top end of the support rod is provided with a connecting groove, the connecting groove is clamped to the bottom end of the first connecting member, a bottom portion of the support rod is connected to a support base, and a control switch is mounted on a side wall of the support rod.

Preferably, the lamp panel is an RGB lamp panel.

Compared with the prior art, the present invention has the beneficial effects as follows:

1 [symbol] A torchiere lamp with a dynamic ambient lighting effect comprises a lighting assembly, the lighting assembly comprises a mounting plate, a lampshade, and a light-transmitting cover, the lampshade is clamped to a top portion of the mounting plate, the light-transmitting cover is clamped to a top portion of the lampshade, an ambient light unit is mounted at the top portion of the mounting plate, the ambient light unit comprises a fixing frame, the fixing frame is provided with a motor mounted thereon, a lamp panel is mounted above the motor, the lamp panel is provided with a through hole, an output end of the motor passes through the through hole and is fixedly connected to a light refraction sheet, a bottom portion of the lampshade is provided with a mounting groove in a convex mode, a laser lamp is mounted in the mounting groove, and the top portion of the lampshade is provided with a laser lamp hole for divergence and transmission of light emitted from a light source of the laser lamp. The lamp panel emits light, the laser lamp emits laser light, the motor operates to drive the light refraction sheet to rotate to achieve changes in refracted light, and the changing light is diverged through the light-transmitting cover, thereby increasing fun of using the torchiere lamp.

### BRIEF DESCRIPTION OF THE DRAWINGS

FIG. 1 is an overall structural schematic diagram of the present invention;

FIG. 2 is a partial structural schematic diagram of the present invention;

FIG. 3 is an enlarged view of A in FIG. 2;

FIG. 4 is a bottom structural schematic diagram of a lighting assembly of the present invention;

FIG. 5 is an internal structural schematic diagram of the lighting assembly of the present invention;

FIG. 6 is an exploded structural schematic diagram of the lighting assembly of the present invention;

FIG. 7 is a top structural schematic diagram of a lampshade of the present invention;

FIG. 8 is an enlarged view of B in FIG. 6; and

in the figures: lighting assembly 1, mounting plate 11, first mounting groove 111, first support groove 112, second support groove 113, connecting threaded-groove 114, first clamping buckle 115, first connecting hole 116, light-transmitting plate 12, abutting member 121, lampshade 13, laser lamp hole 131, first clamping groove 132, clamping block 133, second mounting groove 134, laser lamp 135, second clamping groove 136, through groove 137, light-transmitting cover 14, second clamping buckle 141, support structure 2, support base 21, support rod 22, control switch 221, connecting groove 222, connecting structure 3, first connecting member 31, intermediate member 32, flipping groove 321, ball groove 322, second connecting member 33, ball head 331, threaded end 332, ambient light unit 4, fixing frame 41, third support groove 411, second connecting hole 412, motor 42, connecting lug 421, lamp panel 43, through hole 431, fixing hole 432, light refraction sheet 44.

### DESCRIPTION OF EMBODIMENTS

The technical solutions in the embodiments of the present invention will be described clearly and completely below in conjunction with the drawings in the embodiments of the present invention. Obviously, the described embodiments are merely some rather than all of the embodiments of the present invention. On the basis of the embodiments of the present invention, all other embodiments obtained by a person of ordinary skill in the art without exerting creative efforts should fall within the scope of protection of the present invention.

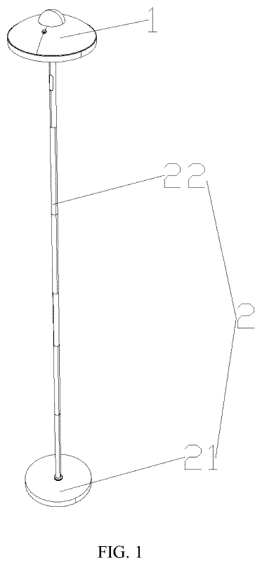

In the description of the present invention, it should be noted that orientation or position relationships indicated by terms, such as “upper”, “lower”, “inside”, “outside”, “front end”, “back end”, “two ends”, “one end”, “other end”, etc., are based on orientation or position relationships shown in FIG. 1 and are merely to facilitate the description of the present invention and simplify the description, rather than indicating or implying that a device or an element referred to must have a specific orientation or be constructed and operated in a specific orientation, and therefore cannot be understood as a limitation to the present invention. In addition, the terms “first” and “second” are only used to describe a purpose and shall not be understood as indicating or implying relative importance.

In the description of the present invention, it should be noted that, unless otherwise clearly specified and defined, terms, such as “install”, “provided with”, “connection”, etc., should be understood in a generalized manner. For example, “connection” may be a fixed connection, a detachable connection, or an integral connection; may be a mechanical connection or an electrical connection; and may be a direct connection, an indirect connection via an intermediate medium, or an internal communication between two elements. For persons of ordinary skill in the art, specific meanings of the above terms in the present invention may be understood according to specific circumstances.

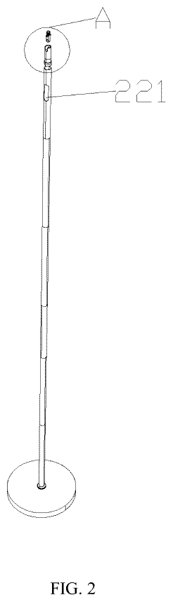

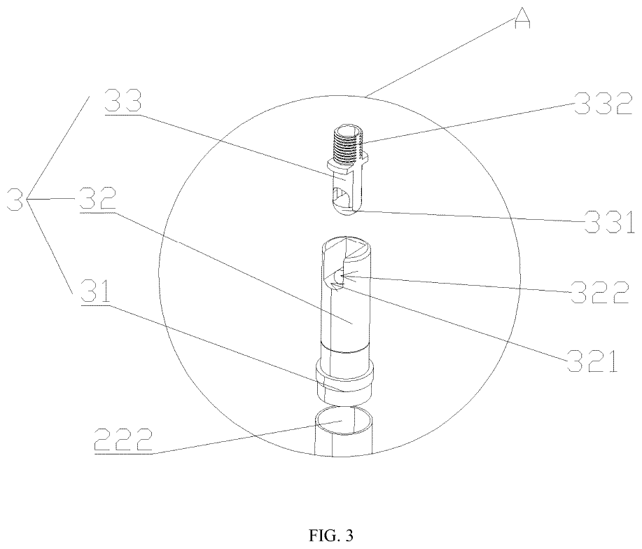

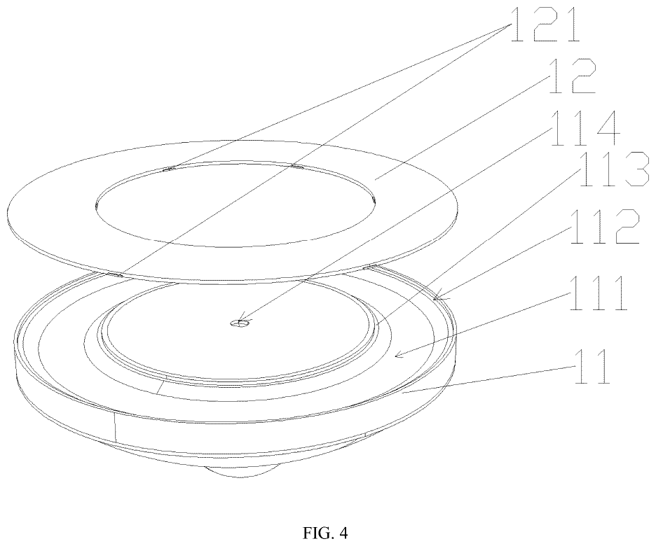

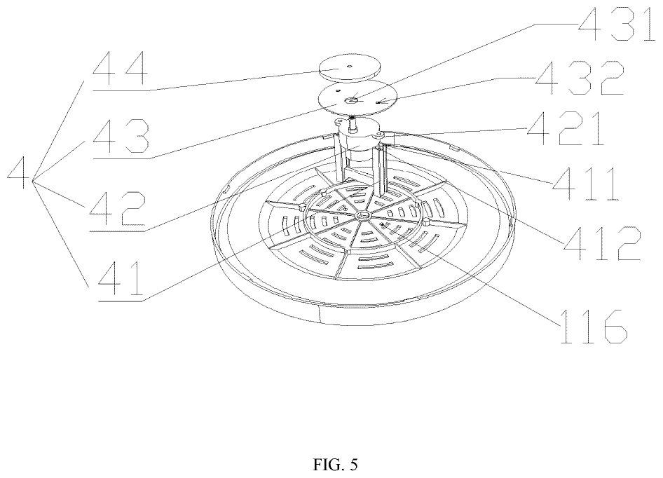

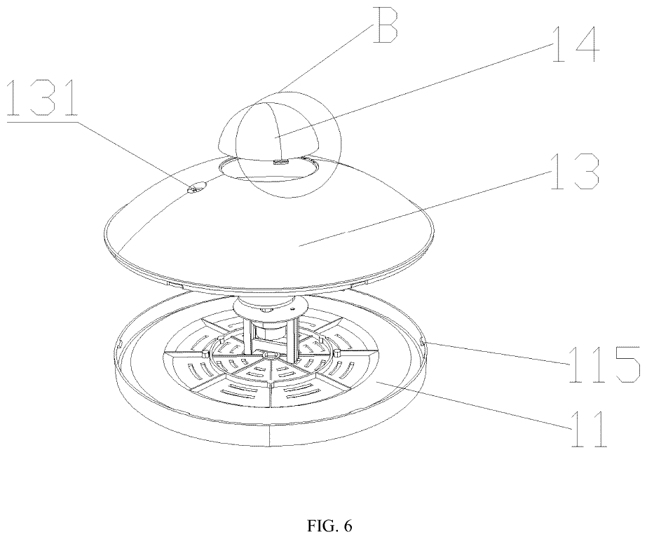

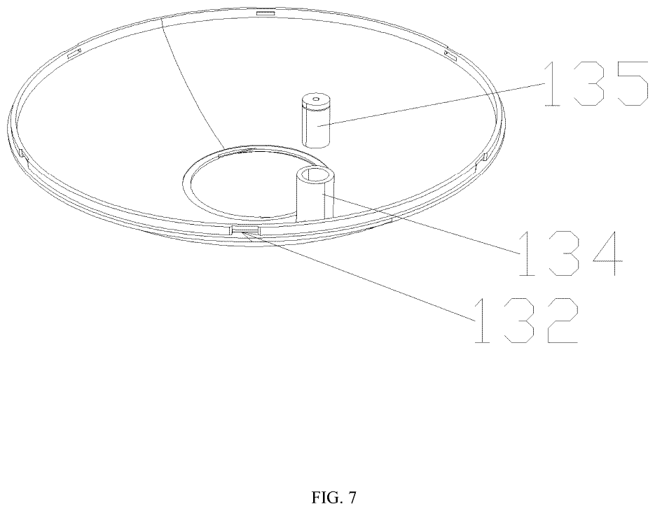

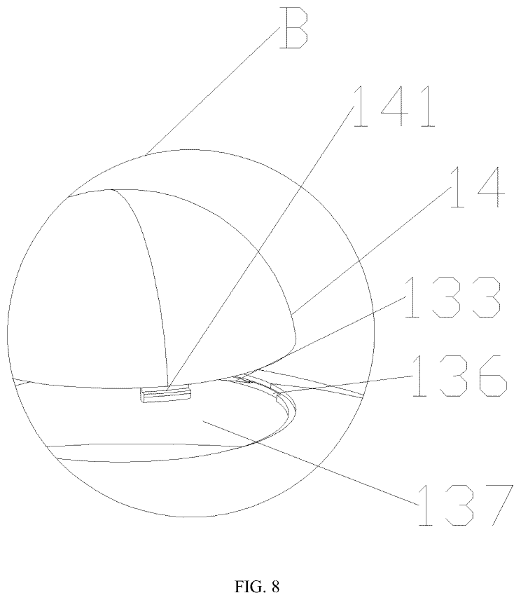

As shown in FIG. 1 to FIG. 8, a torchiere lamp with a dynamic ambient lighting effect in this embodiment comprises a lighting assembly 1, the lighting assembly 1 comprises a mounting plate 11, a lampshade 13, and a light-transmitting cover 14, the lampshade 13 is clamped to a top portion of the mounting plate 11, the light-transmitting cover 14 is clamped to a top portion of the lampshade 13, an ambient light unit 4 is mounted at the top portion of the mounting plate 11, the ambient light unit 4 comprises a fixing frame 41, the fixing frame 41 is provided with a motor 42 mounted thereon, a lamp panel 43 is mounted above the motor 42, the lamp panel 43 is provided with a through hole 431, an output end of the motor 42 passes through the through hole 431 and is fixedly connected to a light refraction sheet 44, a bottom portion of the lampshade 13 is provided with a second mounting groove 134 in a convex mode, a laser lamp 135 is mounted in the second mounting groove 134, and the top portion of the lampshade 13 is provided with a laser lamp hole 131 for divergence and transmission of light emitted from a light source of the laser lamp 135. The lamp panel 43 emits light, the laser lamp 135 emits laser light, the motor 42 operates to drive the light refraction sheet 44 to rotate to achieve changes in refracted light, and the changing light is diverged through the light-transmitting cover 14 to achieve a dynamic ambient effect, thereby increasing fun of using the torchiere lamp. Furthermore, the lamp panel 43 is an RGB lamp panel 43, and the RGB lamp panel itself has good color richness and color mixing capability, thereby improving the dynamic ambient effect of the present invention.

Further, a side wall of the mounting plate 11 is provided with first clamping buckles 115 in a convex mode, the bottom portion of the lampshade 13 is provided with first clamping grooves 132, the mounting plate 11 and the lampshade 13 are clamped together via the first clamping buckles 115 and the first clamping grooves 132, a top end of the lampshade 13 is provided with a through groove 137, a side wall of the through groove 137 is provided with a second clamping groove 136, both sides of the second clamping groove 136 are provided with clamping blocks 133, a bottom end of the light-transmitting cover 14 is provided with a second clamping buckle 141 in a convex mode, the clamping blocks 133 and the second clamping buckle 141 are engaged and clamped together, and a bottom end of one side of each of the clamping blocks 133 is provided with an inclined face for facilitating sliding of the second clamping buckle 141. During installation of the light-transmitting cover 14 and the lampshade 13, after the second clamping buckle 141 is aligned with the second clamping groove 136, the light-transmitting cover 14 is rotated to achieve engagement and clamping of the second clamping buckle 141 and the clamping blocks 133. When the light-transmitting cover 14 needs to be disassembled, the light-transmitting cover 14 is rotated until the second clamping buckle 141 rotates to the second clamping groove 136, and then the light-transmitting cover 14 is removed upward, thereby improving convenience of replacing the light-transmitting cover 14. Furthermore, different light-transmitting covers 14 are provided with different patterns, and different light-transmitting covers 14 are replaced according to demands of different scenarios, thereby improving an application scope and applicable scenarios of the present invention.

Further, top ends of both sides of the fixing frame 41 are provided with third support grooves 411, both sides of the motor 42 are provided with connecting lugs 421 in a convex mode, both the connecting lugs 421 and the lamp panel 43 are provided with corresponding fixing holes 432, the fixing frame 41 is provided with second connecting holes 412 in communication with the fixing holes 432 on bottom surfaces of the third support grooves 411, a bottom surface of the mounting plate 11 is provided with first connecting holes 116 in communication with the second connecting holes 412, the first connecting holes 116 are threaded holes, the motor 42 and the lamp panel 43 sequentially pass through the fixing holes 432 and the second connecting holes 412 and are connected to the first connecting holes 116 in a threaded mode through bolts, and the motor 42, the lamp panel 43, and a fixing member are connected to the mounting plate 11 in a threaded mode through bolts, thereby improving stability of connection of the ambient light unit 4.

Further, a bottom portion of the mounting plate 11 is provided with a first mounting groove 111 for mounting a lighting lamp panel (not shown in the figures), the lighting lamp panel emits light to achieve a lighting function of the present invention, the first mounting groove 111 abuts against a light-transmitting plate 12, the first mounting groove 111 and the light-transmitting plate 12 are both in a circular shape, two side walls of the first mounting groove 111 are respectively provided with a first support groove 112 and a second support groove 113, two side walls of the light-transmitting plate 12 are both provided with abutting members 121 in a convex mode, the abutting members 121 on two sides of the light-transmitting plate 12 respectively abut against a side wall of the first support groove 112 and a side wall of the second support groove 113, and the light-transmitting plate 12 abuts against the mounting plate 11, thereby improving convenience of installing the light-transmitting plate 12.

Further, a center of the mounting plate 11 is provided with a connecting threaded-groove 114, the connecting threaded-groove 114 is connected to a connecting structure 3, the connecting structure 3 comprises a first connecting member 31, a support structure 2 is clamped to a bottom end of the first connecting member 31, a top end of the first connecting member 31 is fixedly connected to an intermediate member 32, a second connecting member 33 is hinged to a top end of the intermediate member 32, the intermediate member 32 is provided with a flipping groove 321, the intermediate member 32 is provided with a ball groove 322 at a bottom end of the flipping groove 321, a bottom end of the second connecting member 33 is provided with a ball head 331 in a convex mode, the ball head 331 and the ball groove 322 are connected in a spherical hinge mode, a top end of the second connecting member 33 is provided with a threaded end 332 in a convex mode, the threaded end 332 and the connecting threaded-groove 114 are connected in a threaded mode, and the ball head 331 and the ball groove 322 are movably fitted, thereby achieving swinging of the lighting assembly 1 of the present invention to a certain angle.

Further, the support structure 2 comprises a support rod 22, a top end of the support rod 22 is provided with a connecting groove 222, the connecting groove 222 is clamped to the bottom end of the first connecting member 31, a bottom portion of the support rod 22 is connected to a support base 21, the support base 21 provides a support force to improve support performance of the present invention, a control switch 221 is mounted on a side wall of the support rod 22, and the control switch 221 controls the lighting assembly 1 and the ambient light unit 4 to be turned on.

Finally, it should be noted that the above description is only for illustrating the preferred embodiments of the present invention, and is not intended to limit the present invention. Although the present invention is illustrated in detail with reference to the aforementioned embodiments, those skilled in the art can still modify the technical solutions recited in the aforementioned embodiments, or perform equivalent substitutions on some technical features therein. Any modifications, equivalent substitutions, and improvements, etc., made within the spirit and principles of the present invention shall be included within the scope of protection of the present invention.

What is claimed is:

1. A torchiere lamp with a dynamic ambient lighting effect, comprising a lighting assembly, wherein the lighting assembly comprises a mounting plate, a lampshade, and a light-transmitting cover, the lampshade is clamped to a top portion of the mounting plate, the light-transmitting cover is clamped to a top portion of the lampshade, an ambient light unit is mounted at the top portion of the mounting plate, the ambient light unit comprises a fixing frame, the fixing frame is provided with a motor mounted thereon, a lamp panel is mounted above the motor, the lamp panel is provided with a through hole, an output end of the motor passes through the through hole and is fixedly connected to a light refraction sheet, a bottom portion of the lampshade is provided with a second mounting groove in a convex mode, a laser lamp is mounted in the second mounting groove, and the top portion of the lampshade is provided with a laser lamp hole for divergence and transmission of light emitted from a light source of the laser lamp.

2. The torchiere lamp with a dynamic ambient lighting effect according to claim 1, wherein a side wall of the mounting plate is provided with first clamping buckles in a convex mode, the bottom portion of the lampshade is provided with first clamping grooves, the mounting plate and the lampshade are clamped together via the first clamping buckles and the first clamping grooves, a top end of the lampshade is provided with a through groove, a side wall of the through groove is provided with a second clamping groove, both sides of the second clamping groove are provided with clamping blocks, a bottom end of the light-transmitting cover is provided with a second clamping buckle in a convex mode, the clamping blocks and the second clamping buckle are engaged and clamped together, and a bottom end of one side of each of the clamping blocks is provided with an inclined face for facilitating sliding of the second clamping buckle.

3. The torchiere lamp with a dynamic ambient lighting effect according to claim 1, wherein top ends of both sides of the fixing frame are provided with third support grooves, both sides of the motor are provided with connecting lugs in a convex mode, both the connecting lugs and the lamp panel are provided with corresponding fixing holes, the fixing frame is provided with second connecting holes in communication with the fixing holes on bottom surfaces of the third support grooves, a bottom surface of the mounting plate is provided with first connecting holes in communication with the second connecting holes, the first connecting holes are threaded holes, and the motor and the lamp panel sequentially pass through the fixing holes and the second connecting holes and are connected to the first connecting holes in a threaded mode through bolts.

4. The torchiere lamp with a dynamic ambient lighting effect according to claim 1, wherein a bottom portion of the mounting plate is provided with a first mounting groove for mounting a lighting lamp panel, and the first mounting groove abuts against a light-transmitting plate.

5. The torchiere lamp with a dynamic ambient lighting effect according to claim 4, wherein the first mounting groove and the light-transmitting plate are both in a circular shape, two side walls of the first mounting groove are respectively provided with a first support groove and a second support groove, two side walls of the light-transmitting plate are both provided with abutting members in a convex mode, and the abutting members on two sides of the light-transmitting plate respectively abut against a side wall of the first support groove and a side wall of the second support groove.

6. The torchiere lamp with a dynamic ambient lighting effect according to claim 1, wherein a center of the mounting plate is provided with a connecting threaded-groove, and the connecting threaded-groove is connected to a connecting structure.

7. The torchiere lamp with a dynamic ambient lighting effect according to claim 6, wherein the connecting structure comprises a first connecting member, a support structure is clamped to a bottom end of the first connecting member, a top end of the first connecting member is fixedly connected to an intermediate member, a second connecting member is hinged to a top end of the intermediate member, the intermediate member is provided with a flipping groove, the intermediate member is provided with a ball groove at a bottom end of the flipping groove, a bottom end of the second connecting member is provided with a ball head in a convex mode, the ball head and the ball groove are connected in a spherical hinge mode, a top end of the second connecting member is provided with a threaded end in a convex mode, and the threaded end and the connecting threaded-groove are connected in a threaded mode.

8. The torchiere lamp with a dynamic ambient lighting effect according to claim 7, wherein the support structure comprises a support rod, a top end of the support rod is provided with a connecting groove, the connecting groove is clamped to the bottom end of the first connecting member, a bottom portion of the support rod is connected to a support base, and a control switch is mounted on a side wall of the support rod.

9. The torchiere lamp with a dynamic ambient lighting effect according to claim 1, wherein the lamp panel is an RGB lamp panel.
